(19) United States
(12) Patent Application Publication
(10) Pub. No.: US 2015/0111114 A1
(43) Pub. Date: Apr. 23, 2015

(54) FUNCTIONAL POROUS MATERIAL, METAL-AIR BATTERY, AND METHOD FOR MANUFACTURING FUNCTIONAL POROUS MATERIAL

(71) Applicant: HITACHI ZOSEN CORPORATION, Osaka (JP)

(72) Inventors: Hidetaka Nakayama, Kyoto (JP); Masanobu Aizawa, Osaka (JP); Takehiro Shimizu, Osaka (JP); Akira Taniguchi, Osaka (JP); Kazuya Kameyama, Osaka (JP); Yuki Nakamura, Osaka (JP); Yoshihiro Asari, Osaka (JP)

(73) Assignee: HITACHI ZOSEN CORPORATION, Osaka (JP)

(21) Appl. No.: 14/396,586

(22) PCT Filed: Apr. 22, 2013
(86) PCT No.: PCT/JP2013/002683

§ 371 Date: Oct. 23, 2014

(30) Foreign Application Priority Data
Apr. 25, 2012 (JP) P2012-099820

(51) Int. Cl. H01M 2/02; H01M 6/02; H01M 8/00; H01M 12/06; H01M 8/02

(52) U.S. Cl. CPC H01M 2/0275; H01M 12/06; H01M 8/028; H01M 8/004; H01M 6/02; H01M 2/026; H01M 2/0262
USPC 429/405; 429/516; 429/535

(57) ABSTRACT

In a metal-air battery, a negative electrode, an electrolyte layer, and a positive electrode are concentrically disposed in the stated order, radially outward from the central axis, and the outer circumferential surface of the positive electrode is enclosed by a liquid-repellent layer (29). The liquid-repellent layer (29) includes a relatively high-strength inorganic porous material (292) having a continuous pore structure, and a fluorine-based porous part (293) formed by fusing fluorine-based particles to each other. The fluorine-based porous part (293) is fused to the inorganic porous material (292) in pores (294) of and on the outer surface (295) of the inorganic porous material (292). This makes it possible to provide the liquid-repellent layer (29) that is a functional porous material having desired mechanical strength, gas permeability, and liquid impermeability.

### TECHNICAL FIELD

The present invention relates to a functional porous material and a manufacturing method therefor, and a metal-air battery using the functional porous material.

### BACKGROUND ART

Conventionally, metal-air batteries that each use a metal as an active material of the negative electrode and oxygen in the air as an active material of the positive electrode are known. In metal-air batteries, a porous PTFE film (polytetrafluoroethylene film) is used as a functional film that suppresses entry of water vapor from the outside, secures gas permeability, and prevents leakage of the electrolyte solution contained in the batteries. A porous PTFE film is also used in a vent plug for releasing gases produced during charging, such as oxygen, hydrogen, and carbon dioxide, to the outside of the batteries and preventing the electrolyte solution contained in the batteries from leaking out.

However, because the porous PTFE film has relatively low mechanical strength, there is, for example, a risk that the porous PTFE film will be damaged or deformed due to a sudden change in pressure caused by gases produced in the batteries during charging, thus causing the electrolyte solution to leak out of the batteries.

In view of this, Japanese Patent Application Laid-Open No. 2009-203584 (Document 1) discloses a technique in which a non-woven fabric having high compressive resistance is used as a structure support in a water-repellent porous material for preventing entry of water vapor on the air electrode side of a fuel cell, and the non-woven fabric is impregnated or coated with a fluoropolymer dissolved in an organic solvent so as to improve compressive resistance.

Japanese Patent Application Laid-Open No. 2002-190431 (Document 2) discloses a technique for forming a functional film by coating a continuous porous film formed by sintering or compression of a metal fiber, with a water-repellent material. Japanese Patent Application Laid-Open No. 63-244554 (Document 3) discloses a vent plug for storage batteries, in which fluorine coating is applied on the inner surfaces of pores of a ceramic porous material.

Meanwhile, Japanese Patent Application Laid-Open No. 2005-329405 (Document 4) discloses a technique for manufacturing a porous multi-layered hollow fiber by winding a porous stretched resin sheet around the outer circumferential surface of a porous stretched PTFE tube, and after application of a load, integrating the whole by sintering. Japanese Patent Application Laid-Open No. 2008-110562 (Document 5) discloses a technique for forming a porous PTFE layer, in which a mesh made of, for example, a metal or ceramics, or a non-woven fabric using a glass fiber or the like is used as a support, and after a porous PTFE film is laminated on the support, the whole is fired at a temperature (250 degrees C.) that is lower than or equal to the melting point of PTFE.

Incidentally, the water-repellent porous material disclosed in Document 1 is likely to, for example, bend because its structure support is made of a relatively flexible non-woven fabric. There is thus a risk that the fluoropolymer coated on the non-woven fabric will be removed from the non-woven fabric. Additionally, because the porosity and water repellency of the water-repellent porous material mainly depend on voids in the non-woven fabric and therefore it is not easy to adjust porosity and water repellency through fluoropolymer coating.

For the functional film disclosed in Document 2, it is necessary to control the compression rate of the metal fiber or to control the thickness of plating applied to the continuous porous film in order to adjust the gas permeability of the functional film. This complicates the process of manufacturing the functional film. In Document 3, the gas permeability of the vent plug mainly depends on the diameter of pores of the ceramic porous material and therefore it is not easy to adjust gas permeability by controlling the amount of fluorine coating applied on the inner surfaces of the pores.

For the porous multi-layered hollow fiber disclosed in Document 4, the porous structures of the porous stretched PTFE tube and the porous stretched resin sheet change because sintering is performed at a high temperature that is higher than or equal to the melting point of PTFE. Thus, it is not easy to manufacture a porous multi-layered hollow fiber having desired gas permeability. In addition, the mechanical strength of the porous multi-layered hollow fiber is relatively low because the tube is formed from PTFE. For the porous PTFE layer disclosed in Document 5, because gas permeability is adjusted by laminating a plurality of PTFE films, the manufacturing process is complicated. Additionally, the mechanical strength of the porous PTFE layer decreases because the PTFE films have poor adhesion to each other.

### SUMMARY OF INVENTION

The present invention is intended for a functional porous material, and it is an object of the present invention to provide a functional porous material having desired mechanical strength, gas permeability, and liquid impermeability. The present invention is also intended for a metal-air battery and a method for manufacturing a functional porous material.

A functional porous material according to the present invention includes an inorganic porous material having a continuous pore structure, a fluorine-based porous part that is formed from fluorine-based particles fused to each other and that is fused to the inorganic porous material in pores of the inorganic porous material.

This makes it possible to provide a functional porous material having desired mechanical strength, gas permeability, and liquid impermeability.

In a preferred embodiment of the present invention, the fluorine-based porous part is further provided on an outer surface of the inorganic porous material and is fused to the outer surface of the inorganic porous material.

More preferably, the functional porous material further includes a fluorine-based porous film that is laminated on the fluorine-based porous part on the outer surface of the inorganic porous material and that is fused to the fluorine-based porous part and integrated with the fluorine-based porous part.

In another preferred embodiment of the present invention, the fluorine particles contain at least one selected from the group consisting of polytetrafluoroethylene (PTFE), tetrafluoroethylene-perfluoroalkylvinylether copolymer (PFA), tetrafluoroethylene-hexafluoropropylene copolymer (FEP), tetrafluoroethylene-hexafluoro-propylene-perfluoroalkylvinylether copolymer (EPE), polychloro-trifluoroethylene (PCTFE), ethylene-tetrafluoroethylene copolymer (ETFE), and ethylene-chlorotrifluoroethylene copolymer (ECTFE).

A meal-air battery according to the present invention includes a porous negative electrode having a tubular shape, and containing a metal, a porous positive electrode having a tubular shape that surrounds an outer surface of the negative electrode, an electrolyte layer disposed between the negative electrode and the positive electrode and containing an electrolyte solution, and a liquid-repellent layer having a tubular shape that surrounds an outer surface of the positive electrode, being formed from the functional porous material according to any one of claims 1 to 4, and allowing permeation of a gas while preventing permeation of the electrolyte solution.

A method for manufacturing a functional porous material according to the present invention includes the steps of: a) disposing fluorine-based particles in pores of an inorganic porous material having a continuous pore structure, and b) fusing the fluorine-based particles to each other by application of heat to the inorganic porous material and the fluorine-based particles, to form a fluorine-based porous part, and fusing the fluorine-based porous part to the inorganic porous material in the pores.

In a preferred embodiment of the present invention, in the step a), the fluorine-based particles are further disposed on an outer surface of the inorganic porous material, and in the step b), the fluorine-based porous part is further formed on the outer surface of the inorganic porous material and fused to the outer surface of the inorganic porous material.

More preferably, the method for manufacturing a functional porous material further includes the steps of: c) after the step b), laminating a fluorine-based porous film on the fluorine-based porous part on the outer surface of the inorganic porous material to obtain a laminate, and d) heating the laminate at a treatment temperature to cause the fluorine-based porous film to be fused to the fluorine-based porous part and to be integrated with the fluorine-based porous part, the treatment temperature being higher than or equal to a temperature that is lower by 100 degrees C. than a melting point of the fluorine-based particles and being lower than or equal to a temperature that is higher by 70 degrees C. than the melting point.

Yet more preferably, the inorganic porous material has a columnar or cylindrical shape, and in the step c), the fluorine-based porous film is spirally wound around the fluorine-based porous part provided on an outer circumferential surface that is the outer surface of the inorganic porous material.

In another preferred embodiment of the present invention, in the step a), the fluorine-based particles are disposed by applying a dispersion of the fluorine-based particles in a liquid dispersion medium to the inorganic porous material, followed by drying.

Preferably, the dispersion contains a polymer dissolvable in the dispersion medium and having a molecular weight of at least 1000.

Alternatively, the dispersion contains a nonionic polymeric surfactant dissolvable in the dispersion medium and having a molecular weight of at least 1000.

In another preferred embodiment of the present invention, the fluorine particles contain at least one selected from the group consisting of polytetrafluoroethylene (PTFE), tetrafluoroethylene-perfluoroalkylvinylether copolymer (PFA), tetrafluoroethylene-hexafluoropropylene copolymer (FEP), tetrafluoroethylene-hexafluoropropylene-perfluoroalkylvinylether copolymer (EPE), polychloro-trifluoroethylene (PCTFE), ethylene-tetrafluoroethylene copolymer (ETFE), and ethylene-chlorotrifluoroethylene copolymer (ECTFE).

These and other objects, features, aspects and advantages of the present invention will become more apparent from the following detailed description of the present invention when taken in conjunction with the accompanying drawings.

### BRIEF DESCRIPTION OF DRAWINGS

FIG. 1 illustrates a configuration of a metal-air battery according to a first embodiment.

FIG. 2 is a transverse cross-sectional view of the metal-air battery.

FIG. 3 is an enlarged cross-sectional view of a liquid-repellent layer.

FIG. 4 is an enlarged cross-sectional view of the vicinity of the outer surface of the liquid-repellent layer.

FIG. 5 is a flowchart of the manufacture of the liquid-repellent layer.

FIG. 6A shows measurement results and test results on samples according to examples and comparative examples.

FIG. 6B shows measurement results and test results on samples according to Examples and Comparative Examples.

FIG. 7 shows an SEM photograph of the surface of a functional porous material of Example 1.

FIG. 8 shows an SEM photograph of the surface of a functional porous material of Example 2.

FIG. 9 shows an SEM photograph of the surface of a functional porous material of Example 3.

FIG. 10 shows an SEM photograph of the surface of a functional porous material of Example 4.

FIG. 11 shows an SEM photograph of the surface of a functional porous material of Example 5.

FIG. 12 shows another SEM photograph of the surface of the functional porous material of Example 5.

FIG. 13 shows an SEM photograph of the surface of a functional porous material of Example 6.

FIG. 14 is an enlarged cross-sectional view of a liquid-repellent layer of a metal-air battery according to a second embodiment.

FIG. 15 is a flowchart of the manufacture of the liquid-repellent layer.

FIG. 16 illustrates a liquid-repellent layer being manufactured.

FIG. 17 shows an SEM photograph of the surface of a functional porous material of Example 8.

### DESCRIPTION OF EMBODIMENTS

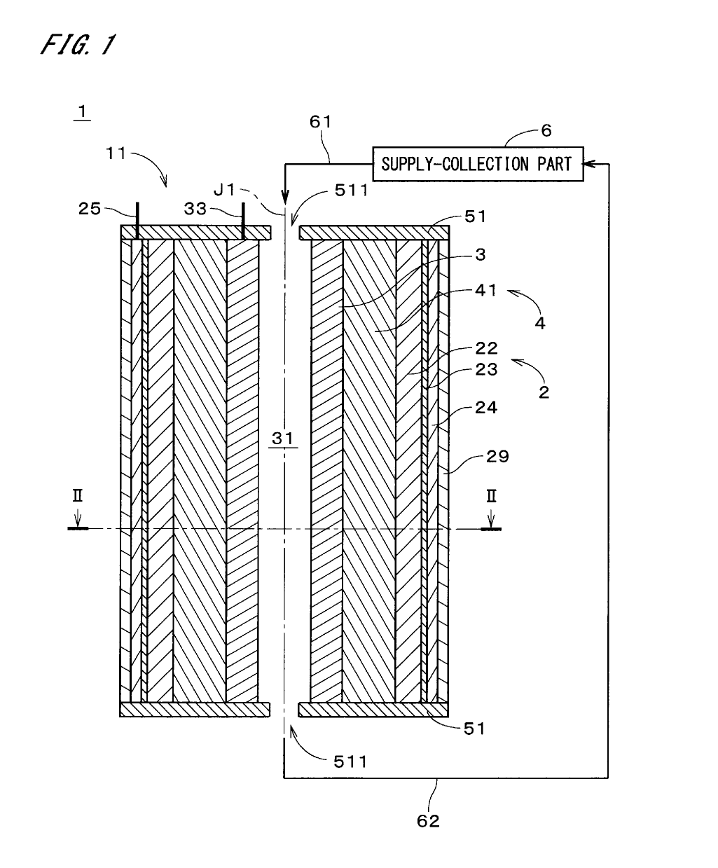

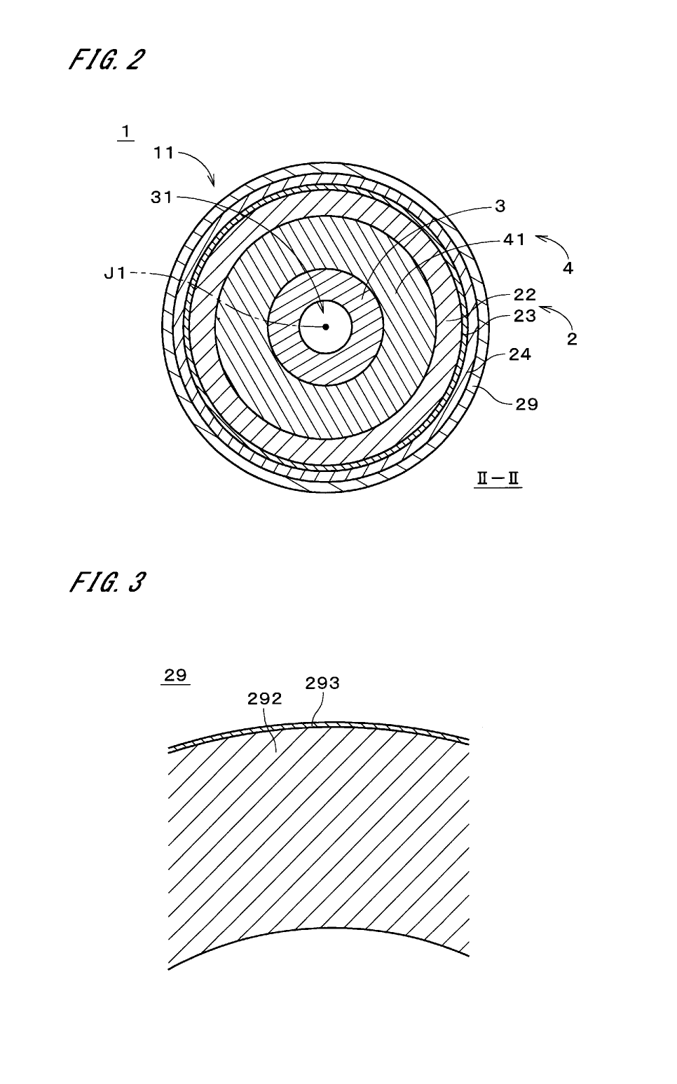

FIG. 1 illustrates a configuration of a metal-air battery 1 according to an embodiment of the present invention. A main body 11 of the metal-air battery 1 has a generally cylindrical shape centered on a central axis J1. In FIG. 1, a cross section of the main body 11 including the central axis J1 is illustrated. FIG. 2 is a transverse cross-sectional view of the main body 11 of the metal-air battery 1, taken along II-II in FIG. 1. As illustrated in FIGS. 1 and 2, the metal-air battery 1 is a secondary battery that includes a positive electrode 2, a negative electrode 3, and an electrolyte layer 4. The negative electrode 3, the electrolyte layer 4, and the positive electrode 2 are concentrically disposed in the stated order, radially outward from the central axis J1. In other words, in the metal-air battery 1, the electrolyte layer 4 containing an electrolyte solution is disposed between the negative electrode 3 and the positive electrode 2 surrounding the outer circumferential surface of the negative electrode 3.

The negative electrode 3 (also referred to as a “metal electrode”) is a tubular porous member centered on the central axis J1 and is formed from a metal such as magnesium (Mg), aluminum (Al), zinc (Zn), or iron (Fe) or an alloy containing any of these metals. In the present embodiment, the negative electrode 3 is formed of zinc in a cylindrical shape having an outer diameter of 11 millimeters (mm) and an inner diameter of 5 mm. As illustrated in FIG. 1, the negative electrode 3 has a negative electrode current collector terminal 33 connected to one end in the direction of the central axis J1 (hereinafter referred to as the “axial direction”). As illustrated in FIGS. 1 and 2, a space 31 surrounded by the inner circumferential surface of the negative electrode 3 (hereinafter, referred to as a “filled part 31”) is filled with an aqueous electrolyte solution (also called “electrolyte”).

The electrolyte layer 4 surrounding the negative electrode 3 is disposed on the outer side of the negative electrode 3. The electrolyte layer 4 includes a tubular porous member 41, the inner circumferential surface of which faces the outer circumferential surface of the negative electrode 3. The electrolyte layer 4 is in communication with the filled part 31 through the pores of the porous negative electrode 3, and the porous member 41 is also filled with the electrolyte solution.

The porous member 41 is formed from a ceramic, a metal, an inorganic material, an organic material, or the like and is preferably a sintered ceramic (i.e., an integrally molded ceramic) having high insulating properties, such as alumina, zirconia, or Hafnia. From the viewpoint of preventing an increase in the distance between the negative electrode 3 and the later-described positive electrode 2 while securing a certain degree of mechanical strength, it is preferable for the porous member 41 to have a thickness that is greater than or equal to 0.5 mm and is less than or equal to 4 mm The electrolyte solution in the present embodiment is a high-concentration aqueous alkaline solution (e.g., 8 mol/L (M) aqueous potassium hydroxide (KOH) solution) that is saturated with zinc oxide. Alternatively, the electrolyte solution may be another aqueous electrolyte solution or a non-aqueous (e.g., organic solvent) electrolyte solution.

The positive electrode 2 (also referred to as an “air electrode”) includes a porous positive electrode conductive layer 22. The positive electrode conductive layer 22 is formed (laminated) in a tubular shape on the outer circumferential surface of the porous member 41 of the electrolyte layer 4. A positive electrode catalyst is supported on the outer circumferential surface of the positive electrode conductive layer 22, thus forming a positive electrode catalyst layer 23. A mesh sheet of metal such as nickel, for example, is wound around the positive electrode catalyst layer 23, forming a current collector layer 24. The current collector layer 24 has a positive electrode current collector terminal 25 connected to one end in the axial direction as illustrated in FIG. 1. In actuality, the positive electrode catalyst is dispersed in the vicinity of the outer circumferential surface of the positive electrode conductive layer 22 and is not formed as a definite layer. Thus, the current collector layer 24 is also partially in contact with the outer circumferential surface of the positive electrode conductive layer 22. Alternatively, an interconnector that is in contact with only part of the outer circumferential surface of the positive electrode conductive layer 22 may be provided as the current collector layer 24.

From the viewpoint of preventing deterioration due to oxidation during charging, which will be described later, it is preferable for the positive electrode conductive layer 22 not to contain carbon. In the present embodiment, the positive electrode conductive layer 22 is a thin porous conductive film formed primarily of a perovskite type oxide having electrical conductivity (e.g., LSMF (LaSrMnFeO₃)). This positive electrode conductive layer 22 is formed by first coating a perovskite type oxide on the outer circumferential surface of the porous member 41 using a slurry coating process and then subjecting the resultant material to firing. Alternatively, the above positive electrode conductive layer 22 may be formed using other methods including a hydrothermal synthesis method, chemical vapor deposition (CVD), and physical vapor deposition (PVD).

The positive electrode catalyst layer 23 is formed from a catalyst that accelerates an oxygen reduction reaction. Examples of the catalyst include oxides of metals such as manganese (Mn), nickel (Ni), and cobalt (Co). In the present embodiment, the positive electrode catalyst layer 23 is formed from manganese dioxide (MnO₂) that is preferentially supported by the positive electrode conductive layer 22, using a hydrothermal synthesis method. Alternatively, the positive electrode catalyst layer 23 may be formed using other methods such as a slurry coating method followed by firing, CVD, and PVD. In the metal-air battery 1, in principle, an interface between the air and the electrolyte solution is formed in the vicinity of the porous positive electrode catalyst layer 23.

As illustrated in FIGS. 1 and 2, a liquid-repellent layer 29 formed from a functional porous material is disposed on the outer circumferential surface of the current collector layer 24 (including portions of the outer circumferential surface of the positive electrode catalyst layer 23 that are not covered with the mesh current collector layer 24). The liquid-repellent layer 29 has a tubular shape that surrounds the outer circumferential surface of the positive electrode 2. The liquid-repellent layer 29 allows permeation of gases and prevents permeation of electrolyte solutions. The details of the functional porous material forming the liquid-repellent layer 29 will be described later.

As illustrated in FIG. 1, disk-shaped closure members 51 are fixed to opposite end faces (top and bottom end faces in FIG. 1) of the negative electrode 3, the electrolyte layer 4, and the positive electrode 2 in the axial direction. The closure members 51 each have a through hole 511 formed in the center and the through holes 511 open into the filled part 31. In the metal-air battery 1, the liquid repellent layer 29 and the closure members 51 serve to prevent the electrolyte solution in the main body 11 from leaking out to the outside other than through the through holes 511. One end of a supply pipe 61 is connected to the through hole 511 of one of the closure members 51, and the other end of the supply pipe 61 is connected to a supply-collection part 6. A collection pipe 62 is connected to the through hole 511 of the other closure member 51, and the other end of the collection pipe 62 is connected to the supply-collection part 6. The supply-collection part 6 includes a reservoir tank for storing an electrolyte solution and a pump. In the metal-air battery 1, an electrolyte solution is circulated if necessary between the filled part 31 and the reservoir tank of the supply-collection part 6, for example, in the case where the discharge voltage drops due to deterioration of the electrolyte solution.

When the metal-air battery 1 in FIG. 1 is discharged, the negative electrode current collector terminal 33 and the positive electrode current collector terminal 25 are electrically connected to each other via a load (e.g., lighting fitting). The metal contained in the negative electrode 3 is oxidized into metal ions (here, zinc ions (Zn²+)), and electrons are supplied to the positive electrode 2 through the negative electrode current collector terminal 33, the positive electrode current collector terminal 25, and the current collector layer 24. In the porous positive electrode 2, the oxygen in the air that has peimeated the liquid repellent layer 29 is reduced by the electrons supplied from the negative electrode 3 into hydroxide ions (OH⁻) in the case where the aqueous electrolyte solution is used. In the positive electrode 2, since the generation of hydroxide ions (i.e., reduction reaction of oxygen) is accelerated by the positive electrode catalyst, overvoltage due to the energy consumed in the reduction reaction decreases, and accordingly the discharge voltage of the metal-air battery 11 can be increased.

On the other hand, when the metal-air battery 1 is charged, a voltage is applied between the negative electrode current collector terminal 33 and the positive electrode current collector terminal 25. In the positive electrode 2, electrons are supplied from the hydroxide ions to the positive electrode current collector terminal 25 through the current collector layer 24, and oxygen is produced. In the negative electrode 3, metals ions are reduced by the electrons supplied to the negative electrode current collector terminal 33, and a metal is deposited on the surface (outer circumferential surface). In the positive electrode 2, since the production of oxygen is accelerated by the positive electrode catalyst contained in the positive electrode catalyst layer 23, overvoltage decreases, and the charge voltage of the metal-air battery 1 can be reduced.

Next is a description of the liquid-repellent layer 29. FIG. 3 is an enlarged transverse cross-sectional view of part of the generally cylindrical liquid-repellent layer 29. As illustrated in FIG. 3, the liquid-repellent layer 29 includes an inorganic porous material 292 and a fluorine-based porous part 293. The inorganic porous material 292 is a generally cylindrical member having a continuous pore structure. In the present embodiment, the inorganic porous material 292 is formed from sintered alumina and has an average pore diameter of approximately 10 micrometers. The inorganic porous material 292 may also be formed from, for example, a porous carbon material, a porous ceramic material, a porous glass material, a sintered metal material, a sintered metal oxide material, or a porous conductive material.

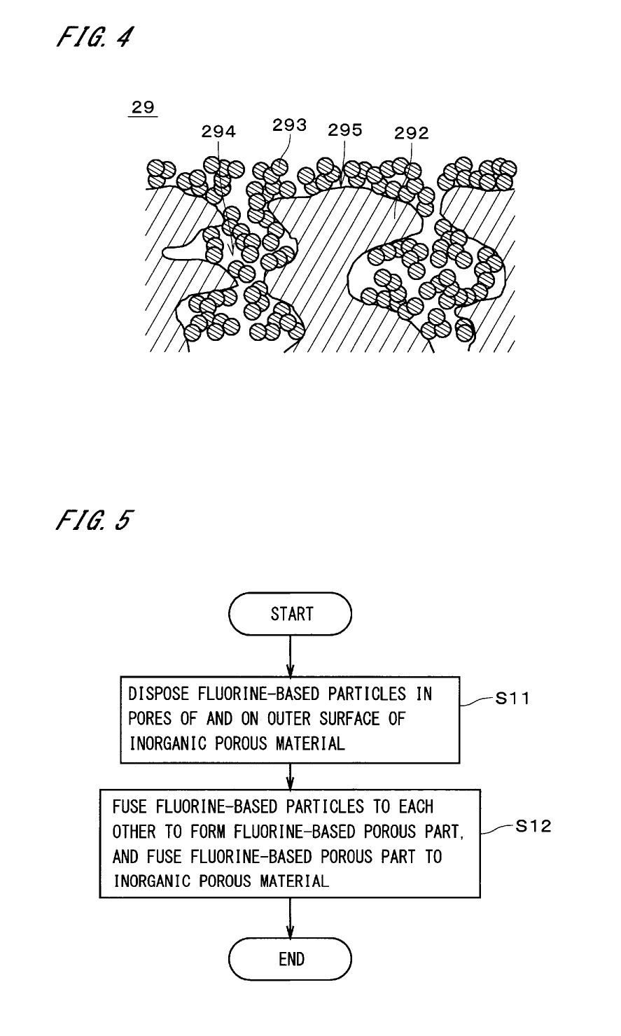

FIG. 4 is an enlarged transverse cross-sectional view of the vicinity of the outer circumferential surface that is the outer surface of the liquid-repellent layer 29. As illustrated in FIG. 4, the fluorine-based porous part 293 is provided in pores 294 of and on the outer surface (i.e., outer circumferential surface) 295 of the inorganic porous material 292. In the fluorine-based porous part 293, portions that are positioned on the outer surface 295 of the inorganic porous material 292 have a generally cylindrical shape, and in the present embodiment, these portions cover substantially the entire outer surface 295 of the inorganic porous material 292. The fluorine-based porous part 293 are made substantially porous as a result of a large number of fluorine-based particles being fused to each other, and the fluorine-based porous part 293 is fused to the inner surfaces of the pores 294 of the inorganic porous material 292 and the outer surface 295 of the inorganic porous material 292.

It is preferable for the fluorine-based particles forming the fluorine-based porous part 293 to contain at least one selected from the group consisting of polytetrafluoroethylene (PTFE), tetrafluoroethylene-perfluoroalkylvinylether copolymer (PFA), tetrafluoroethylene-hexafluoropropylene copolymer (FEP), tetrafluoroethylene-hexafluoropropylene-perfluoroalkylvinylether copolymer (EPE), polychloro-trifluoroethylene (PCTFE), ethylene-tetrafluoroethylene copolymer (ETFE), and ethylene-chlorotrifluoroethylene copolymer (ECTFE). In this case, it is possible to obtain the fluorine-based porous part 293 that is excellent in chemical resistance, heat resistance, and liquid repellency to the electrolyte solution used in the metal-air battery 1.

Next, a method for manufacturing the liquid-repellent layer 29 (i.e., functional porous material) will be described with reference to FIG. 5. First, a dispersion in which fluorine-based particles are dispersed in a liquid dispersion medium is prepared. The primary particle diameters (hereinafter, simply referred to as “diameters”) of the fluorine-based particles contained in the dispersion are less than the average pore diameter of the inorganic porous material 292 and are preferably greater than or equal to 0.05 micrometers and less than or equal to 8.0 micrometers, and more preferably greater than or equal to 0.16 micrometers and less than or equal to 0.5 micrometers. In the present embodiment, the diameters of the fluorine-based particles are approximately 0.25 micrometers. As the fluorine-based particles, particles of PTFE are used.

If the fluorine-based particles have diameters of 8.0 micrometers or less, phase separation due to precipitation of fluorine-based particles can be suppressed during the production of the dispersion, and it is possible to easily and uniformly disperse fluorine-based particles in the dispersion medium. If the fluorine-based particles have diameters of 0.5 micrometers or less, it is easier to uniformly disperse the fluorine-based particles. If the fluorine-based particles have diameters of 0.05 micrometers or more, an increase in cost due to processes such as size classification and filtration can be suppressed during the production of the dispersion. If the fluorine-based particles have diameters of 0.16 micrometers or more, an increase in the production cost of the dispersion can be further suppressed.

As the dispersion medium of the dispersion, various liquids are usable. For example, water may be used as the dispersion medium, and in order to control the wettability of the dispersion medium, a liquid obtained by doping water with an appropriate amount of an organic solvent such as ethyl alcohol or isopropyl alcohol may be used.

It is preferable for the dispersion to contain a polymer dissolvable in the dispersion medium and having a molecular weight of at least 1000 as a thickner. The polymer that is less influenced by the pH composition of the dispersion and has less influence on the dispersibility of fluorine-based particles is preferably used. For example, one or a mixture of two or more selected from the group consisting of polyethylene glycol (PEG), polyethylene oxide (PEO), polypropylene oxide (PO), polyvinyl alcohol (PVA), starch, ethyl cellulose (EC), hydroxyethyl cellulose (HEC), xanthan gum, carboxyvinyl polymer, and agarose is contained as the above polymer in the dispersion.

It is also preferable for the dispersion to contain a nonionic polymeric surfactant dissolvable in the dispersion medium and having a molecular weight of at least 1000. A nonionic polymeric surfactant that has less influence on the dispersibility of fluorine-based particles is preferably used. For example, one or a mixture of two or more selected from the group consisting of polyoxyethylene alkyl ethers, polyoxy alkylene derivatives, polyoxyethylene sorbitan fatty acid esters, polyoxyethylene sorbitol fatty acid esters, polyoxyethylene fatty acid esters, polyoxyethylene hydrogenated castor oils, polyoxyethylene alkylamines, and polyoxyethylene alkyl alkanolamide is contained as the above nonionic polymeric surfactant in the dispersion.

Note that the dispersion may contain only one of the aforementioned polymer and the aforementioned nonionic polymeric surfactant and does not necessarily have to contain both of them. Alternatively, the dispersion may contain a cationic surfactant or an anionic surfactant other than the nonionic polymeric surfactant.

Next, the inorganic porous material 292 is immersed for a predetermined period of time in the above dispersion held in a vessel, and the dispersion is applied to the inorganic porous material 292. In the present embodiment, the inorganic porous material 292 is immersed in the dispersion in a state in which end faces of the cylindrical inorganic porous material 292 on opposite axial sides and openings in the inner space of the inorganic porous material 292 (i.e., space inside of the inner circumferential surface of the inorganic porous material 292) are sealed with a cap formed from silicon or the like. Thus, the dispersion enters the pores 294 to a desired depth from the outer surface 295 of the inorganic porous material 292 (i.e., a desired position that is radially inward from the outer surface 295) without entering the whole pores 294 of the inorganic porous material 292. Note that the dispersion may be caused to enter the whole pores 294 of the inorganic porous material 292 by changing, for example, the shape of the cap or the viscosity of the dispersion.

After the immersion of the inorganic porous material 292 has ended, the inorganic porous material 292 is taken out of the above vessel and dried, as a result of which a layer of the dispersion (hereinafter referred to as the “dispersion layer”) is formed in the pores 294 of and on the outer surface 295 of the inorganic porous material 292. In other words, fluorine-based particles are disposed together with the dispersion medium in the pores 294 of and on the outer surface 295 of the inorganic porous material 292 (step S11).

Then, the dispersion layer containing fluorine-based particles and the inorganic porous material 292 are heated for a predetermined period of time. Through this, the fluorine-based particles are fused to each other in the pores 294 of and the outer surface 295 of the inorganic porous material 292, forming the fluorine-based porous part 293. The fluorine-based porous part 293 is fused to the inorganic porous material 292 in the pores 294 and is also fused to the outer surface 295 of the inorganic porous material 292 (step S12). Through this heat treatment, the dispersion medium in the dispersion layer is removed from inside of the pores 294 of and on the outer surface 295 of the inorganic porous material 292. Similarly to the dispersion medium, the polymer and the nonionic polymeric surfactant that are dissolved in the dispersion medium as described above are also removed from inside of the pores 294 of and on the outer surface 295 of the inorganic porous material 292.

The treatment temperature during the heat treatment in step S12 is preferably higher than or equal to a temperature that is lower by 100 degrees C. than the melting point of fluorine-based particles (in the present embodiment, 327 degrees C., which is the melting point of PTFE), and is preferably lower than or equal to a temperature that is higher by 70 degrees C. than the melting point of fluorine-based particles. If the treatment temperature is higher than or equal to the temperature lower by 100 degrees C. than the melting point of fluorine-based particles, it is possible to relatively shorten the amount of time from the start of heating to the fusion of fluorine-based particles and to make practical the time required to manufacture the liquid-repellent layer 29. If the treatment temperature is lower than or equal to the temperature higher by 70 degrees C. than the melting point of fluorine-based particles, the porous structure of the fluorine-based porous part 293 can be easily controlled to achieve the desired average pore diameter. The above treatment temperature is more preferably higher than or equal to a temperature that is lower by 80 degrees C. than the melting point of fluorine-based particles, and is more preferably lower than or equal to a temperature that is higher by 60 degrees C. than the melting point of fluorine-based particles. Yet more preferably, the treatment temperature is higher than or equal to a temperature that is lower by 60 degrees C. than the melting point of fluorine-based particles, and is lower than or equal to a temperature that is higher by 50 degrees C. than the melting point of fluorine-based particles. In the present embodiment, the inorganic porous material 292 provided with the dispersion layer is heated at approximately 350 degrees C. for 10 minutes in an electric furnace.

As described above, the fluorine-based porous part 293 has a porous structure and is excellent in water repellency. In other words, a contact angle of the fluorine-based porous part 293 is large, and a wettability of the fluorine-based porous part 293 is low. Thus, the liquid-repellent layer 29 prevents permeation of electrolyte solution while allowing permeation of gases. The gas permeability and liquid impermeability of the liquid-repellent layer 29 can be easily adjusted by adjusting the average pore diameter of the fluorine-based porous part 293 and the radial thickness of the fluorine-based porous part 293. The radial thickness of the fluorine-based porous part 293 as used herein refers to a distance in the radial direction between the outer circumferential surface of the fluorine-based porous part 293 (i.e., the outer circumferential surface of the portions of the fluorine-based porous part 293 that are positioned on the outer surface 295 of the inorganic porous material 292) and an average position of the radial inner edge of the fluorine-based porous part 293 in the pores 294. For example, increasing the average pore diameter of the fluorine-based porous part 293 improves the gas permeability of the liquid-repellent layer 29 and reduces the liquid impermeability of the liquid-repellent layer 29. Meanwhile, increasing the radial thickness of the fluorine-based porous part 293 reduces the gas permeability of the liquid-repellent layer 29 and improves the liquid impermeability of the liquid-repellent layer 29.

In the manufacture of the liquid-repellent layer 29, the average pore diameter of the fluorine-based porous part 293 can be easily adjusted by adjusting, for example, the diameters of the fluorine-based particles, the ratio (i.e., density) of the fluorine-based particles in the dispersion layer, and the treatment temperature and time of the heat treatment in step S12. The above density of the fluorine-based particles on the outer surface 295 of the inorganic porous material 292 can be easily adjusted by adjusting, for example, the solids concentration of the fluorine-based particles in the dispersion and the viscosity of the dispersion. The density of the fluorine-based particles in the pores 294 of the inorganic porous material 292 can be easily adjusted by adjusting, for example, the ratio of the diameters of the fluorine-based particles to the average pore diameter of the inorganic porous material 292, the amount of time during which the inorganic porous material 292 is immersed in the dispersion, the solids concentration of the fluorine-based particles in the dispersion, and the viscosity of the dispersion.

For example, increasing the treatment temperature of the heat treatment increases the thicknesses of fused portions of the fluorine-based particles and reduces the average pore diameter of the fluorine-based porous part 293. Even if the same treatment temperature is used, increasing the treatment time increases the thicknesses of fused portions of the fluorine-based particles and reduces the average pore diameter of the fluorine-based porous part 293. The average pore diameter of the fluorine-based porous part 293 can also be reduced by increasing the viscosity of the dispersion. This is considered due to the packing effect (i.e., effect of gathering the fluorine-based particles) brought by the thickner in the dispersion medium. A decrease in the average pore diameter of the fluorine-based porous part 293 reduces the gas permeability of the liquid-repellent layer 29 and improves the liquid impermeability of the liquid-repellent layer 29.

Increasing the density of the fluorine-based particles in the dispersion layer improves the gas permeability of the liquid-repellent layer 29 and also improves the liquid impermeability of the liquid-repellent layer 29. An improvement in gas permeability is considered due to a low degree of fusion of the fluorine-based particles in the fluorine-based porous part 293. Thus, if the treatment temperature of the heat treatment is increased, even if the density of the fluorine-based particles is increased, the fluorine-based particles are sufficiently fused to each other in the fluorine-based porous part 293 and accordingly the gas permeability of the liquid-repellent layer 29 become deteriorated.

In the manufacture of the liquid-repellent layer 29, the amount of dispersion applied to the inorganic porous material 292 (i.e., the depth of the dispersion filled in the pores 294 of the inorganic porous material 292 and the thickness of the dispersion layer formed on the outer surface 295 of the inorganic porous material 292) can be easily adjusted by adjusting, for example, the average pore diameter of the inorganic porous material 292, the concentration (i.e., solids concentration) of the fluorine-based particles in the dispersion, the viscosity of the dispersion, the amount of time during which the inorganic porous material 292 is immersed in the dispersion, and the number of times that the inorganic porous material 292 is immersed in the dispersion. Accordingly, the radial thickness of the fluorine-based porous part 293 can be easily adjusted.

For example, reducing the average pore diameter of the inorganic porous material 292 can increase the thickness of the fluorine-based porous part 293 formed on the outer surface 295 of the inorganic porous material 292. This improves the liquid impermeability of the liquid-repellent layer 29. The gas permeability of the liquid-repellent layer 29 is the same as in the aforementioned case where the density of the fluorine-based particles in the dispersion layer is increased. That is, the gas permeability increases when the treatment temperature is relatively low, whereas the gas permeability decreases when the treatment temperature is relatively high.

Hereinafter, the present invention will be described in further detail using examples, but the present invention is not intended to be limited to these examples.

In Examples 1 to 8 described below, the average pore diameter and thickness of the fluorine-based porous part 293 of each functional porous material were measured, and a gas permeation test and an anti-hydraulic test were conducted on each functional porous material. In Comparative Examples 1 to 3, the gas permeation test and the anti-hydraulic test were conducted on inorganic porous materials 292 with no fluorine-based porous parts 293. A sample that showed a high amount of gas permeation in the gas permeation test has high gas permeability, and a sample that showed a high anti-water pressure characteristic in the anti-hydraulic test has higher liquid impermeability.

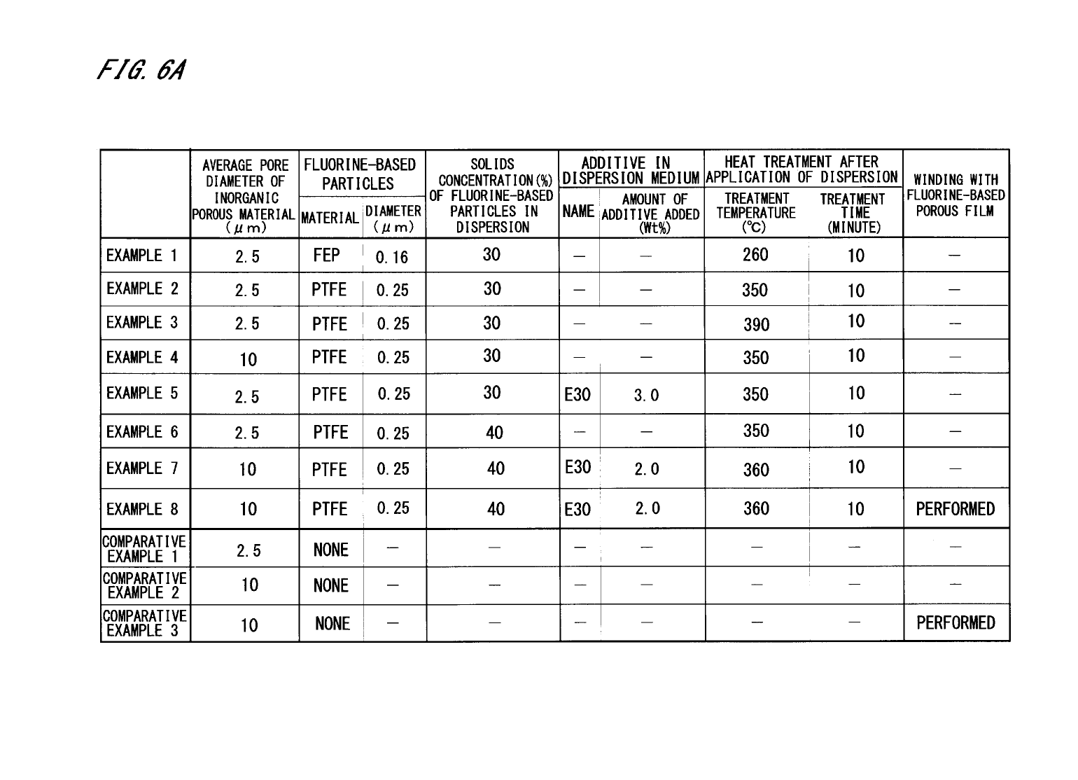

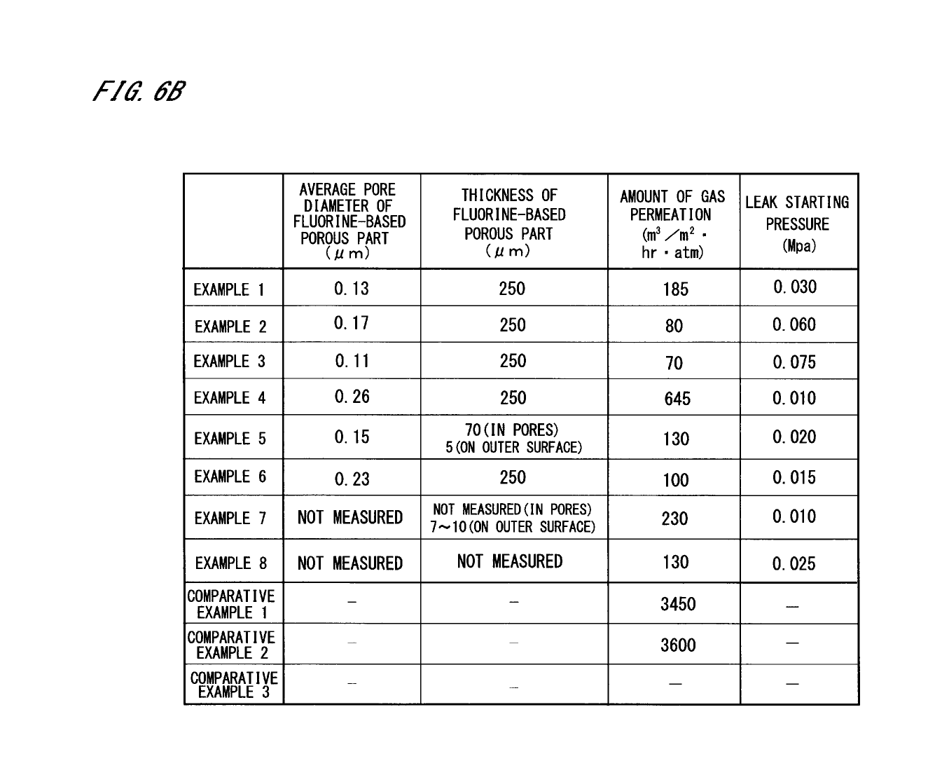

The average pore diameter of the fluorine-based porous part 293 is obtained as an average value of the diameters of 10 randomly selected pores by observation of the surface of the fluorine-based porous part 293 with a scanning electron microscope (hereinafter referred to as the “SEM”). The thicknesses of the fluorine-based particles are measured by observation using the SEM. In the gas permeation test, nitrogen is supplied at a pressure (gauge pressure) of 0.020 MPa from one side of a sample and the amount of nitrogen permeation is measured, using a gas permeation measuring device. In the anti-hydraulic test, water is filled in a space that is inside of the inner circumferential surface of a cylindrical sample, and pressure is applied to the water for a predetermined period of time to obtain a minimum pressure at which water leakage occurs at the outer circumferential surface of the sample, as a leak starting pressure. FIGS. 6A and 6B show measurement results, test results, and the like on samples of Examples 1 to 8 and Comparative Examples 1 to 3. FIG. 6A shows the conditions for the samples, and FIG. 6B shows the measurement results and the test results. Note that

Example 8 and Comparative Example 3 will be described later in a second embodiment, which will be described later.

### EXAMPLE 1

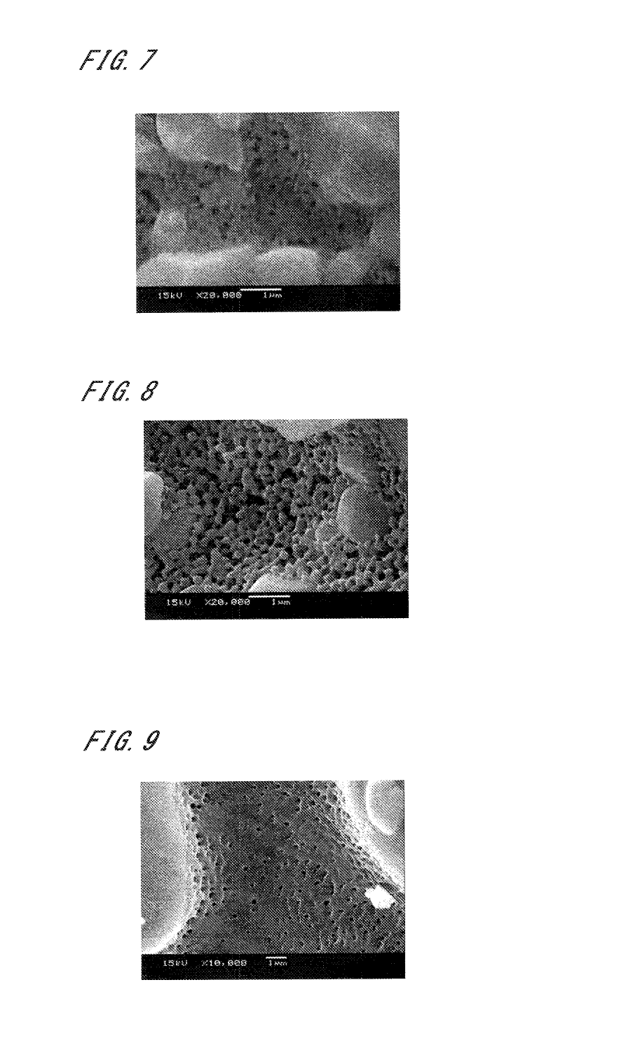

FIG. 7 shows an SEM photograph of the surface of a functional porous material of Example 1. FIG. 7 shows the surface of the fluorine-based porous part 293 in the pores 294 of the inorganic porous material 292 (the same applies to FIGS. 8 to 11 and FIG. 13). In Example 1, cylindrical porous sintered alumina having an average pore diameter of 2.5 micrometers (a length of 5 cm, an inner diameter of 12 mm, and an outer diameter of 16 mm) was used as the inorganic porous material 292. As a dispersion of fluorine-based particles, an FEP dispersion (manufactured by Du Point-Mitsui Fluorochemicals Co., Ltd. and having an average particle diameter of 0.16 micrometers) having a solids concentration adjusted to 30% with distilled water was used.

In Example 1, with the axial opposite ends of the inorganic porous material 292 sealed with silicon caps, the inorganic porous material 292 was immersed in the above dispersion for four minutes and was then dried at 120 degrees C. Thereafter, the inorganic porous material 292 provided with the dispersion layer was heated at approximately 260 degrees C. for 10 minutes in an electric furnace to obtain a functional porous material. In Example 1, almost no fluorine-based porous part 293 was formed on the outer surface 295 of the inorganic porous material 292 (the same applies to Examples 2 to 4 and 6). According to Example 1, the fluorine-based porous part 293 in the pores 294 of the inorganic porous material 292 had an average pore diameter of 0.13 micrometers and a thickness of approximately 250 micrometers. The amount of gas permeation measured by the gas permeation test was 185 m³/m²*hr*atm, and the leak starting pressure measured by the anti-hydraulic test was 0.030 MPa.

### EXAMPLE 2

FIG. 8 shows an SEM photograph of the surface of a functional porous material of Example 2. In Example 2, the same inorganic porous material 292 as that of Example 1 was used. As a dispersion of fluorine-based particles, a PTFE dispersion (manufactured by Asahi Glass Co. Ltd. and having an average particle diameter of 0.25 micrometers) having a solids concentration adjusted to 30% with distilled water was used. In Example 2, with the axial opposite ends of the inorganic porous material 292 sealed with silicon caps, the inorganic porous material 292 was immersed in the above dispersion for four minutes and was then dried at 120 degrees C. Thereafter, the inorganic porous material 292 provided with the dispersion layer was heated at approximately 350 degrees C. for 10 minutes in an electric furnace to obtain a functional porous material. According to Example 2, the fluorine-based porous part 293 in the pores 294 of the inorganic porous material 292 had an average pore diameter of 0.17 micrometers and a thickness of approximately 250 micrometers. The amount of gas permeation was 80 m³/m²*hr*atm, and the leak starting pressure was 0.060 MPa.

### EXAMPLE 3

FIG. 9 shows an SEM photograph of the surface of a functional porous material of Example 3. In Example 3, a functional porous material was obtained through the same procedure as in Example 2, with the exception that the heating temperature in step S12 was approximately 390 degrees C. According to Example 3, the fluorine-based porous part 293 in the pores 294 of the inorganic porous material 292 had an average pore diameter of 0.11 micrometers and a thickness of approximately 250 micrometers. The amount of gas permeation was 70 m³/m²*hr*atm, and the leak starting pressure was 0.075 MPa.

### EXAMPLE 4

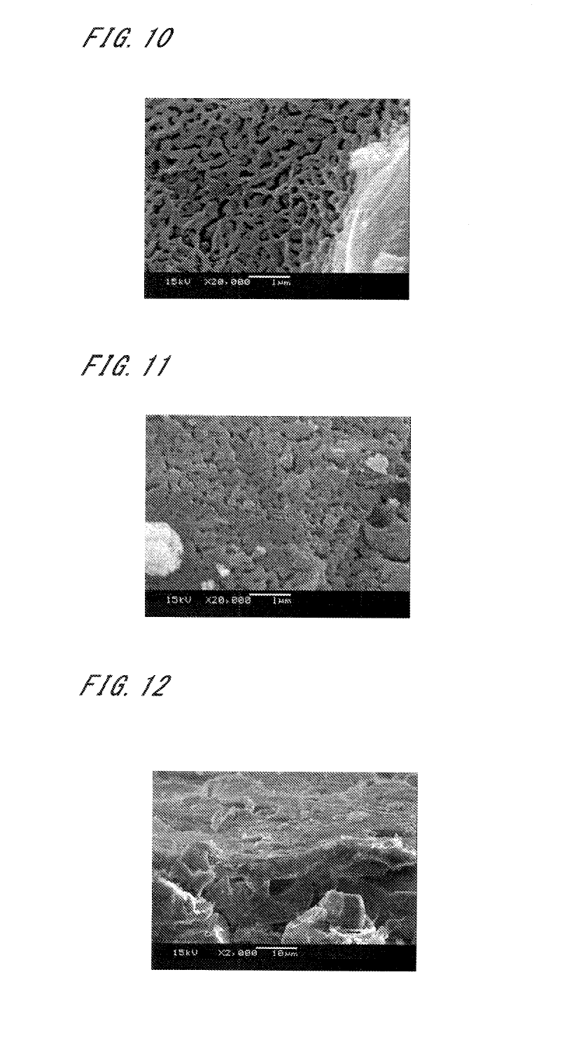

FIG. 10 shows an SEM photograph of the surface of a functional porous material of Example 4. In Example 4, a functional porous material was obtained through the same procedure as in Example 2, with the exception that cylindrical porous sintered alumina having an average pore diameter of 10 micrometers (a length of 5 cm, an inner diameter of 12 mm, and an outer diameter of 16 mm) was used as the inorganic porous material 292. According to Example 4, the fluorine-based porous part 293 in the pores 294 of the inorganic porous material 292 had an average pore diameter of 0.26 micrometers and a thickness of approximately 250 micrometers. The amount of gas permeation was 645 m³/m²*hr*atm, and the leak starting pressure was 0.010 MPa.

### EXAMPLE 5

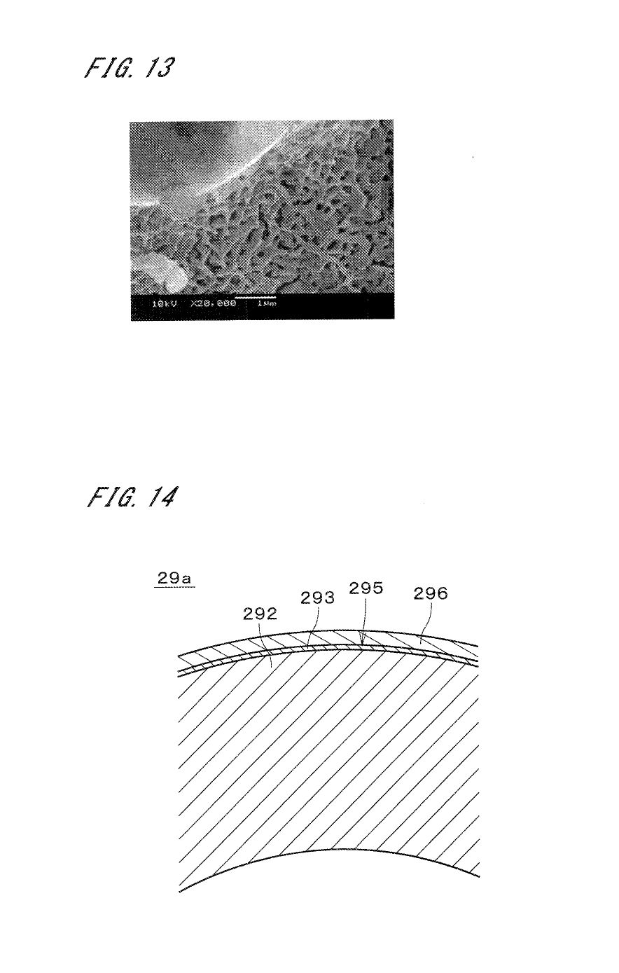

FIGS. 11 and 12 show SEM photographs of the surface of a functional porous material of Example 5. FIG. 11 shows the surface of the fluorine-based porous part 293 in the pores 294 of the inorganic porous material 292, and FIG. 12 shows the surface of the fluorine-based porous part 293 on the outer surface 295 of the inorganic porous material 292. In Example 5, a functional porous material was obtained through the same procedure as in Example 2, with the exception that a PTFE dispersion (manufactured by Asahi Glass Co. Ltd. and having an average particle diameter of 0.25 micrometers) having a solids concentration adjusted to 30% with distilled water and having a viscosity adjusted to 200 cps with an additive of a 3.0 wt % aqueous thickner E-30 (manufactured by Meisei Chemical Works, Ltd.) was used as a dispersion of fluorine-based particles. In Example 5, the fluorine-based porous part 293 was further formed on the outer surface 295 of the inorganic porous material 292. According to Example 5, the fluorine-based porous part 293 in the pores 294 of the inorganic porous material 292 had an average pore diameter of 0.15 micrometers and a thickness of approximately 70 micrometers. The fluorine-based porous part 293 on the outer surface 295 of the inorganic porous material 292 had a thickness of approximately 5 micrometers. The amount of gas permeation was 130 m³/m²Thr*atm, and the leak starting pressure was 0.020 MPa.

### EXAMPLE 6

FIG. 13 shows an SEM photograph of the surface of a functional porous material of Example 6. In Example 6, a functional porous material was obtained through the same procedure as in Example 2, with the exception that a PTFE dispersion (manufactured by Asahi Glass Co. Ltd. and having an average particle diameter of 0.25 micrometers) having a solids concentration adjusted to 40% with distilled water was used as a dispersion of fluorine-based particles. According to Example 6, the fluorine-based porous part 293 in the pores 294 of the inorganic porous material 292 had an average pore diameter of 0.23 micrometers and a thickness of approximately 250 micrometers. The amount of gas permeation was 100 m³/m²*hr*atm, and the leak starting pressure was 0.015 MPa.

### EXAMPLE 7

In Example 7, a PTFE dispersion (manufactured by Asahi Glass Co. Ltd. and having an average particle diameter of 0.25 micrometers) having a solids concentration adjusted to 40% with distilled water and having a viscosity adjusted to 100 cps with an additive of 2.0 wt % aqueous thickner E-30 (manufactured by Meisei Chemical Works, Ltd.) was used as a dispersion of fluorine-based particles. The treatment temperature of the heat treatment in step S12 was 360 degrees C. Excluding the aforementioned points, a functional porous material of Example 7 was obtained through the same procedure as in Example 4. According to Example 7, the fluorine-based porous part 293 on the outer surface 295 of the inorganic porous material 292 had a thickness in the range of approximately 7 to 10 micrometers. The average pore diameter and thickness of the fluorine-based porous part 293 in the pores 294 of the inorganic porous material 292 were not measured. The amount of gas permeation was 230 m³/m² *hr*atm, and the leak starting pressure was 0.010 MPa.

### COMPARATIVE EXAMPLE 1

In Comparative Example 1, the same inorganic porous material as that of Example 1, i.e., cylindrical porous sintered alumina having an average pore diameter of 2.5 micrometers (a length of 5 cm, an inner diameter of 12 mm, and an outer diameter of 16 mm) was used as a sample. The amount of gas permeation of the sample was 3450 m³/m²*hr*atm. The leak starting pressure was immeasurable because of heavy water leakage.

### COMPARATIVE EXAMPLE 2

In Comparative Example 2, the same inorganic porous material as that of Example 4, i.e., cylindrical porous sintered alumina having an average pore diameter of 10 micrometers (a length of 5 cm, an inner diameter of 12 mm, and an outer diameter of 16 mm) was used as a sample. The amount of gas permeation of the sample was 3600 m³/m²*hr*atm. The leak starting pressure was immeasurable because of heavy water leakage.

As described above, the liquid-repellent layer 29 includes the relatively high-strength inorganic porous material 292 having a continuous pore structure, and the fluorine-based porous part 293 formed by fusing fluorine-based particles to each other and fused to the inorganic porous material 292 in the pores 294. This enables the liquid-repellent layer 29 to serve as a functional porous material having desired mechanical strength, gas permeability, and liquid impermeability. The fluorine-based porous part 293 is further provided on the outer surface 295 of the inorganic porous material 292 and is fused to the outer surface 295. By adjusting the thickness of the fluorine-based porous part 293 formed on the outer surface 295 of the inorganic porous material 292, the gas permeability and liquid impermeability of the liquid-repellent layer 29 can be more easily adjusted.

In the manufacture of the liquid-repellent layer 29, fluorine-based particles can be easily disposed in the pores 294 of and on the outer surface 295 of the inorganic porous material 292 by applying a dispersion of fluorine-based particles to the inorganic porous material 292 and then drying the whole. As a result, the liquid-repellent layer 29 can be easily manufactured.

As described above, in the manufacture of the liquid-repellent layer 29, the viscosity of the dispersion can be easily adjusted to desired viscosity by dissolving a polymer having a molecular weight of at least 1000 in the dispersion medium of the dispersion. Thus, in step S11, the dispersion layer can be easily further formed on the outer surface 295 of the inorganic porous material 292. Furthermore, because a gel film is formed when the dispersion layer is dried, fluorine-based particles are brought into close contact with each other in the dispersion layer. This makes it possible to form the fluorine-based porous part 293 having a desired average pore diameter in step S12. Moreover, when the dispersion medium is water, the occurrence of cracks due to surface tension caused by water evaporation can be suppressed by dissolving the aforementioned polymer in the dispersion medium.

In the manufacture of the liquid-repellent layer 29, by dissolving a nonionic polymeric surfactant having a molecular weight of at least 1000 in the dispersion medium, it is possible to suppress the production of a precipitate due to aggregation of fluorine-based particles in the dispersion and to improve liquid stability of the dispersion. As a result, the process of re-dispersing fluorine-based particles in the dispersion prior to the application of the dispersion in step S11 can be omitted or shortened. Furthermore, as in the case where the aforementioned polymer having a molecular weight of at least 1000 is dissolved in the dispersion medium, if the aforementioned monionic polymeric surfactant is dissolved in the dispersion medium, it is possible to easily adjust the viscosity of the dispersion and to easily form the dispersion layer further on the outer surface 295 of the inorganic porous material 292 in step S11. Moreover, the fluorine-based porous part 293 having a desired average pore diameter can be easily formed in step S12. In addition, when the dispersion medium is water, the occurrence of cracks can also be suppressed.

FIG. 14 is an enlarged transverse cross-sectional view of part of a liquid-repellent layer 29a of a metal-air battery according to a second embodiment of the present invention. The liquid-repellent layer 29a that is a functional porous material is the same as the liquid-repellent layer 29 illustrated in FIGS. 3 and 4, with the exception that the liquid-repellent layer 29a further includes a fluorine-based porous film 296. In the following description, corresponding constituent elements are denoted by the same reference numerals.

As illustrated in FIG. 14, the fluorine-based porous film 296 is laminated on the fluorine-based porous part 293 provided on the outer surface (outer circumferential surface) 295 of a generally cylindrical inorganic porous material 292. In the present embodiment, the fluorine-based porous film 296 covers substantially the entire circumferential surface of the fluorine-based porous part 293. The fluorine-based porous film 296 is fused to the fluorine-based porous part 293 and integrated with the fluorine-based porous part 293.

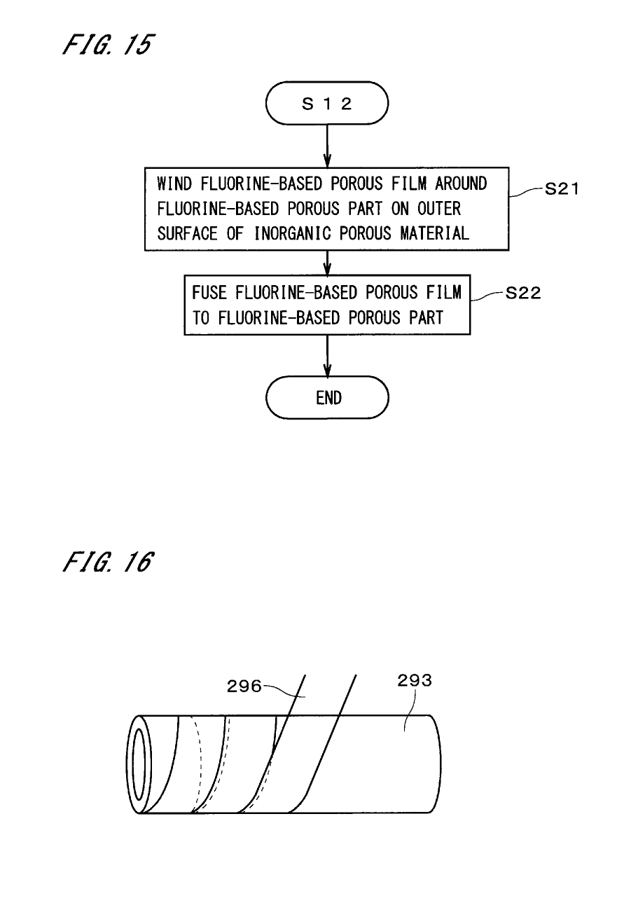

Next, a method for manufacturing the liquid-repellent layer 29a will be described with reference to FIG. 15. In the manufacture of the liquid-repellent layer 29a, first, steps S11 and S12 in FIG. 5 are performed to form the fluorine-based porous part 293 in the pores 294 of and on the outer surface 295 of the inorganic porous material 292 (see FIG. 4). Then, as illustrated in FIG. 16, the fluorine-based porous film 296 is spirally wound around the fluorine-based porous part 293 provided on the outer surface 295 of the inorganic porous material 292, producing a laminate in which the fluorine-based porous film 296 is laminated on the fluorine-based porous part 293 provided on the outer surface 295 of the inorganic porous material 292 (step S21).

Thereafter, the laminate is heated for a predetermined period of time. Through this, the fluorine-based porous film 296 is fused to the fluorine-based porous part 293 and integrated with the fluorine-based porous part 293 (step S22). In other words, the fluorine-based porous part 293 on the outer surface 295 of the inorganic porous material 292 serves as an adhesive and bonds the inorganic porous material 292 and the fluorine-based porous film 296 to each other.

The treatment temperature of the heat treatment performed in step S22 is preferably higher than or equal to a temperature that is lower by 100 degrees C. than the melting point of fluorine-based particles (in the present embodiment, 327 degrees C., which is the melting point of PTFE), and is lower than or equal to a temperature that is higher by 70 degrees C. than the melting point of fluorine-based particles. If the treatment temperature is higher than or equal to the temperature lower by 100 degrees C. than the melting point of the fluorine-based particles, the amount of time from the start of heating to the fusion can be relatively shortened, and it is possible to make practical the time required to manufacture the liquid-repellent layer 29a. If the treatment temperature is lower than or equal to the temperature higher by 70 degrees C. than the melting point of fluorine-based particles, the porous structure of the fluorine-based porous part 293 can be easily maintained. More preferably, the above treatment temperature is higher than or equal to a temperature that is lower by 80 degrees C. than the melting point of fluorine-based particles, and is lower than or equal to a temperature that is higher by 60 degrees C. than the melting point of fluorine-based particles. It is further preferable for the above treatment temperature to be higher than or equal to a temperature that is lower by 60 degrees C. than the melting point of fluorine-based particles and to be lower than or equal to a temperature that is higher by 50 degrees C. than the melting point of fluorine-based particles.

### EXAMPLE 8

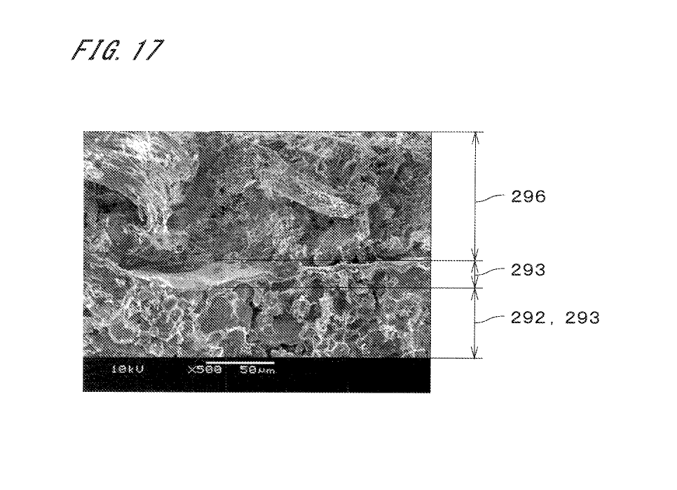

FIG. 17 shows a SEM photograph of a cross section in the vicinity of the surface of a functional porous material of Example 8. The functional porous material of Example 8 was obtained by spirally winding a fluorine-based porous film 296 having a thickness of approximately 70 micrometers around the outer circumferential surface of the functional porous material of Example 7 and then heating the whole at approximately 370 degrees C. for 10 minutes in an electric furnace. A central portion in the vertical direction in FIG. 17 corresponds to the fluorine-based porous part 293 on the outer surface 295 of the inorganic porous material 292. An upper portion above the central portion corresponds to the fluorine-based porous film 296, and a lower portion below the central portion corresponds to the inorganic porous material 292 and the fluorine-based porous part 293 in the pores 294. In Example 8, the amount of gas permeation was 130 m³/m²*hr*atm, and the leak starting pressure was 0.025 MPa.

### COMPARATIVE EXAMPLE 3

In Comparative Example 3, a sample used was obtained by winding a porous PTFE sheet on the outer circumferential surface of the same inorganic porous material as that of Comparative Example 2 and then heating the whole at approximately 350 degrees C. for 10 minutes in an electric furnace. Because the porous PTFE sheet was removed from the inorganic porous material, the amount of gas permeation and the leak starting pressure were both immeasurable in the gas permeation test and the anti-hydraulic test.

In Example 8, the amount of gas permeation is smaller than in Example 7, but the leak starting pressure is higher than in Example 7. That is, the liquid-repellent layer 29a according to the second embodiment has improved liquid impermeability as a result of the provision of the fluorine-based porous film 296 that is fused to and integrated with the fluorine-based porous part 293 provided on the outer surface (outer circumferential surface) 295 of the liquid inorganic porous material 292. The liquid-repellent layer 29a can also have improved mechanical strength. Furthermore, by spirally winding the fluorine-based porous film 296 around the fluorine-based porous part 293 on the outer surface 295 of the inorganic porous material 292, the fluorine-based porous film 296 can be easily laminated on the fluorine-based porous part 293.

While the above has been descriptions of embodiments of the present invention, the present invention is not intended to be limited to the above-described embodiments and can be modified in various ways.

The application of fluorine-based particles to the inorganic porous material 292 in step S11 may be performed by, for example, coating the outer surface 295 of the inorganic porous material 292 with a dispersion of fluorine-based particles. For example, if the inorganic porous material 292 is long, the dispersion may be continuously or automatically applied using an air gun or an airbrush by axially moving the inorganic porous material 292 while rotating it in the circumferential direction. Alternatively, fluorine-based particles may be disposed in the pores 294 of or on the outer surface 295 of the inorganic porous material 292 by powder coating of powdered fluorine-based particles.

In the manufacture of the liquid-repellent layers 29 and 29a, prior to step S11, priming may be performed on the inorganic porous material 292, using a silane coupling agent or the like. Through this, the adhesion between the inorganic porous material 292 and the fluorine-based particles can be improved. Alternatively, prior to priming, the inorganic porous material 292 may be degreased by impregnating the inorganic porous material 292 with an organic solvent such as alcohols or ketones.

The above-described functional porous material including the inorganic porous material 292 and the fluorine-based porous part 293 may be used in various applications other than being used as the liquid-repellent layers 29 and 29a of the metal-air batteries 1. For example, the functional porous material may be used as a liquid-repellent layer of fuel cells other than metal-air batteries, and may also be used as a vent plug for various fuel cells including metal-air batteries, i.e., a plug for exhausting gases produced in the cells during charging. The functional porous material may also be used as a filter medium, a filter, or a moisture-permeable waterproof material.

The shape of the functional porous material is not limited to a cylindrical shape, and functional porous materials of various shapes may be manufactured by applying fluorine-based particles and heat to inorganic porous materials 292 of various shapes such as a plate-like shape, a spherical shape, and a columnar shape. A columnar functional porous material may be manufactured by spirally winding a fluorine-based porous film around the fluorine-based porous part 293 provided on the outer surface (outer circumferential surface) 295 of a columnar inorganic porous material 292 in steps S21 and S22 and then applying heat to integrate the fluorine-based porous film 296 with the fluorine-based porous part 293.

The configurations of the above-described embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1 Metal-air battery

2 Positive electrode

3 Negative electrode

4 Electrolyte layer

29, 29a Liquid-repellent layer

292 Inorganic porous material

293 Fluorine-based porous part

294 Pore

295 Outer surface

296 Fluorine-based porous film

S11, S12, S21, S22 Step

1. A functional porous material comprising:
an inorganic porous material having a continuous pore structure;
a fluorine-based porous part that is formed from fluorine-based particles fused to each other and that is fused to said inorganic porous material in pores of said inorganic porous material.

2. The functional porous material according to claim 1, wherein
said fluorine-based porous part is further provided on an outer surface of said inorganic porous material and is fused to said outer surface of said inorganic porous material.

3. The functional porous material according to claim 2, further comprising:
a fluorine-based porous film that is laminated on said fluorine-based porous part on said outer surface of said inorganic porous material and that is fused to said fluorine-based porous part and integrated with said fluorine-based porous part.

4. The functional porous material according to claim 1, wherein
said fluorine particles contain at least one selected from the group consisting of polytetrafluoroethylene (PTFE), tetrafluoroethylene-perfluoroalkylvinylether copolymer (PFA), tetrafluoroethylene-hexafluoropropylene copolymer (FEP), tetrafluoroethylene-hexafluoropropylene-perfluoroalkylvinylether copolymer (EPE), polychloro-trifluoroethylene (PCTFE), ethylene-tetrafluoroethylene copolymer (ETFE), and ethylene-chlorotrifluoroethylene copolymer (ECTFE).

5. A metal-air battery comprising:
a porous negative electrode having a tubular shape, and containing a metal;
a porous positive electrode having a tubular shape that surrounds an outer surface of said negative electrode;
an electrolyte layer disposed between said negative electrode and said positive electrode and containing an electrolyte solution; and
a liquid-repellent layer having a tubular shape that surrounds an outer surface of said positive electrode, being formed from the functional porous material according to claim 1, and allowing permeation of a gas while preventing permeation of said electrolyte solution.

6. A method for manufacturing a functional porous material, comprising the steps of:
a) disposing fluorine-based particles in pores of an inorganic porous material having a continuous pore structure; and
b) fusing said fluorine-based particles to each other by application of heat to said inorganic porous material and said fluorine-based particles, to form a fluorine-based porous part, and fusing said fluorine-based porous part to said inorganic porous material in said pores.

7. The method for manufacturing a functional porous material, according to claim 6, wherein
in said step a), said fluorine-based particles are further disposed on an outer surface of said inorganic porous material, and
in said step b), said fluorine-based porous part is further formed on said outer surface of said inorganic porous material and fused to said outer surface of said inorganic porous material.

8. The method for manufacturing a functional porous material, according to claim 7, further comprising the steps of:
c) after said step b), laminating a fluorine-based porous film on said fluorine-based porous part on said outer surface of said inorganic porous material to obtain a laminate; and
d) heating said laminate at a treatment temperature to cause said fluorine-based porous film to be fused to said fluorine-based porous part and to be integrated with said fluorine-based porous part, the treatment temperature being higher than or equal to a temperature that is lower by 100 degrees C. than a melting point of said fluorine-based particles and being lower than or equal to a temperature that is higher by 70 degrees C. than said melting point.

9. The method for manufacturing a functional porous material, according to claim 8, wherein,
said inorganic porous material has a columnar or cylindrical shape, and
in said step c), said fluorine-based porous film is spirally wound around said fluorine-based porous part provided on an outer circumferential surface that is said outer surface of said inorganic porous material.

10. The method for manufacturing a functional porous material, according to claim 6, wherein
in said step a), said fluorine-based particles are disposed by applying a dispersion of said fluorine-based particles in a liquid dispersion medium to said inorganic porous material, followed by drying.

11. The method for manufacturing a functional porous material, according to claim 10, wherein
said dispersion contains a polymer dissolvable in said dispersion medium and having a molecular weight of at least 1000.

12. The method for manufacturing a functional porous material, according to claim 10, wherein
said dispersion contains a nonionic polymeric surfactant dissolvable in said dispersion medium and having a molecular weight of at least 1000.

13. The method for manufacturing a functional porous material, according to claim 6, wherein
said fluorine particles contain at least one selected from the group consisting of polytetrafluoroethylene (PTFE), tetrafluoroethylene-perfluoroalkylvinylether copolymer (PFA), tetrafluoroethylene-hexafluoropropylene copolymer (FEP), tetrafluoroethylene-hexafluoropropylene-perfluoalkylvinylether copolymer (EPE), polychloro-trifluoroethylene (PCTFE), ethylene-tetrafluoroethylene copolymer (ETFE), and ethylene-chlorotrifluoroethylene copolymer (ECTFE).
